(19) United States
(12) Patent Application Publication
(10) Pub. No.: US 2012/0301872 A1
(43) Pub. Date: Nov. 29, 2012

(54) SYSTEM AND METHOD FOR INCREASED FLUORESCENCE DETECTION

(75) Inventor: Stig Tormod, Uppsala (SE)

(73) Assignee: GE HEALTHCARE BIO-SCIENCES AB, UPPSALA (SE)

(21) Appl. No.: 13/510,975

(22) PCT Filed: Nov. 17, 2010
(86) PCT No.: PCT/SE10/51265

§ 371 Date: Aug. 10, 2012

(30) Foreign Application Priority Data
Nov. 20, 2009 (SE) 0950882-1

(51) Int. Cl. G01N 21/62; B01L 9/00; G01N 21/64; G01N 21/76; B82Y 15/00

(52) U.S. Cl. 435/5; 436/172; 436/501; 435/7.1; 435/29; 422/561; 977/774; 977/920

(57) ABSTRACT

The invention relates to systems and methods for improving optical detection and sensitivity in situations in which emission of luminescent light is monitored. It is provided a sample carrier which achieves increased sensitivity of luminescent light detection. The sample carrier comprises a sample carrying part and a light reflecting part; wherein the light reflecting part is positioned to allow an optical collection and detection system to collect not only luminescent light emitted from the sample positioned on the sample carrying part in a direction of the optical collection and detection system, but also luminescent light emitted from the sample in a direction away from the optical collection and detection system and reflected in the direction of the optical collection and detection system via the light reflecting part. When an excitation light source is needed, the light reflecting part also allows the excitation light rays passing through the sample to hit the light reflecting part, and reflect back in the opposite direction thus the reflected excitation light also passes through the sample. Also provided are methods of using such a sample carrier.

### TECHNICAL FIELD

The present invention relates to a method and a system for improving optical detection and sensitivity. More particularly, the present invention relates to a method and a system for improving optical detection and sensitivity in situations in which emission of luminescent light is monitored.

### BACKGROUND

Optical detection is used intensively in many fields and for a variety of applications. In many cases, the optical signal emitted by or from a viewed or analyzed object is very low, on the border of detection. Vast efforts are therefore directed at increasing the sensitivity of detection of optical and electro-optical systems, or, in other words, at increasing the ability of optical or electro-optical systems to detect light signals of lesser intensity.

Fluorescence microscopy provides an example. Fluorescence microscopy is one of the most powerful techniques for analyzing tissues and cells. Unlike bright field microscopy where light is transmitted through an analyzed sample, in fluorescence microscopy, a signal appears only with respect to specific entities that emit light, whereas the background is left dark. This fact makes fluorescence microscopy a very sensitive method for detecting both the existence and distribution of materials in a sample and their quantities. Fluorescence microscopy is therefore one of the most important experimental methods used in light microscopy.

Thus, in fluorescence microscopy, an analyzed sample is emitting light, a phenomenon known as fluorescence. The fluorescence light can be native to the analyzed sample, or it can be as a result of an interaction between the analyzed sample and a probe. Some probes are chemicals that fluoresce under certain conditions. For example, probes are known that chemifluoresce differently according to a level of a chemical, e.g., an ion, such as hydrogen or calcium ions, present in the sample or portions thereof. Such probes are therefore useful in determining the concentration and/or distribution of a particular ion in the sample. Other probes include a binding portion and a fluorescent tag. The binding portion can be, for example, a first member of a binding pair, capable of binding a second member of a binding pair present in the sample. The members of a binding pair can be, for example, a ligand that binds a receptor and vice versa, an antibody that binds an antigen and vice versa, a nucleic acid that binds it complement, a substrate, product, inhibitor or analog that binds its enzyme and vice versa, etc. The fluorescent tag is typically a fluorochrome covalently linked to the first member of a binding pair and serves to monitor binding to the second member of the binding pair present in the analyzed sample. Many fluorochromes are presently known each is characterized by a unique absorption spectrum and absorption peak and emission spectrum and peak. Examples of fluorochromes include, fluorescent proteins, such as green, yellow, cyan and red fluorescent proteins and smaller chemical compounds such as fluorescein-5-iso-thiocyanate (FITC), rodamine, SpectrumOrange®, SpectrumGreen®, Aqua, Texas-Red, 4′,6-diamidino-2-phenylindole (DAPI), Cy3, Cy5.5. Hundreds of other fluorochromes are known.

Improvements were also introduced in the detection of fluorescence. Imaging microscopy employing highly sensitive charge coupled devices (CCD) are used intensively and improve many aspects of detection, including, but not limited to, higher sensitivity, larger number of probes that can be co-detected, accurate quantitative analysis and automation. In addition, confocal microscopy which employs laser scanning mechanisms combined with confocal optics that improves the accuracy in the depth of field is also intensively used. These detection methods have broadened the use of fluorescence microscopy.

Fluorescence detection is also widely used in the fields of (i) biological material carrying chips; and (ii) electrophoretic separation and detection of biomolecules, such as nucleic acids, proteins, peptides or carbohydrates from a variety of sources. In both cases, one of the preferred detection methods involves fluorescence light detection.

Fluorescence detection is acquiring major importance in a variety of technological fields. The desired level of detection, or in other words, the desired level of sensitivity, is increased as samples are becoming smaller and smaller. As an example, in detecting DNA arrays on chip in a process of evaluating gene expression, the question that has to be answered is not as simple as a yes/no question. The main issue is the extent to which every sequence is hybridized to as to determine an expression level of a gene or genes. The higher the accuracy of measurement is, the more information will result and the more accurate the analysis will be. The detection system is one of the major limiting factors in this sense.

There is thus a great need for, and it would be highly advantageous to have a novel approach for fluorescence detection that will increase the sensitivity by which existing optics can detect fluorescence light.

### BRIEF DESCRIPTION OF THE PRESENT INVENTION

The present invention relates to systems and methods for improving optical detection and sensitivity in situations in which emission of luminescent light is monitored.

In a first aspect, the invention provides a sample carrier that provides increased sensitivity of luminescent light detection. The sample carrier comprises a sample carrying part and a light reflecting part; wherein the light reflecting part is positioned to allow an optical collection and detection system to collect not only luminescent light emitted from the sample positioned on the sample carrying part in a direction of the optical collection and detection system, but also luminescent light emitted from the sample in a direction away from the optical collection and detection system and reflected in the direction of the optical collection and detection system via the light reflecting part. When an excitation light source is needed, the light reflecting part is also positioned to allow the excitation light rays passing through the sample to hit the light reflecting part, and reflect back in the opposite direction thus the reflected excitation light also passes through the sample.

In a second aspect, the invention provides a method of increasing the sensitivity of an optical collection and detection system in detecting luminescent light emitted from a sample. The method comprises positioning the sample on a sample carrier comprising a sample carrying part and a light reflecting part, wherein the optical collection and detection system collects both (1) luminescent light emitted from the sample positioned on the sample carrying part in a direction of the optical collection and detection system, and (2) luminescent light emitted from the sample in a direction away from the optical collection and detection system and reflected in the direction of the optical collection and detection system via the light reflecting part; thereby increasing the sensitivity of luminescent light detection. When an excitation light source is required, the light reflecting part is also positioned such that excitation light rays passing through the sample hit the light reflecting part, and reflect back in the opposite direction thus the reflected excitation light also passes through the sample.

### BRIEF DESCRIPTION OF THE DRAWINGS

FIG. 1 illustrates a schematic ray path for fluorescent detection using the sample carrier according to an embodiment of the invention.

FIG. 2 provides an enlarged view of a portion of FIG. 1 which illustrates the same principle.

### DEFINITIONS

A corner reflector is a retroreflector consisting of three mutually perpendicular, intersecting flat surfaces, which reflects electromagnetic waves back towards the source. The three intersecting surfaces often have square shapes. This is also known as a corner cube. In optics, corner reflectors typically consist of three mirrors or reflective prisms which return an incident light beam in the opposite direction.

### DETAILED DESCRIPTION OF THE INVENTION

A challenge in fluorescence analysis including fluorescence scanning and spectroscopy is to have the highest possible sensitivity of the measurements. Efficient light collection is key to achieving this. Efficient illumination of the sample is also important for non-autofluorescent samples. The embodiments of the invention provide a sample carrier and method which achieves these goals with a simple yet elegant design.

The present invention is thus of a method and a system which can be used for improving optical detection and sensitivity. Specifically, the present invention can be used to improve optical detection and sensitivity in situations in which luminescence is monitored.

As used herein, the term “luminescence” refers to the emission of light not caused by incandescence and occurring at a temperature below that of incandescent bodies and includes, for example, fluorescence, autofluorescence, chemifluorescence, electroluminescence and chemiluminescence.

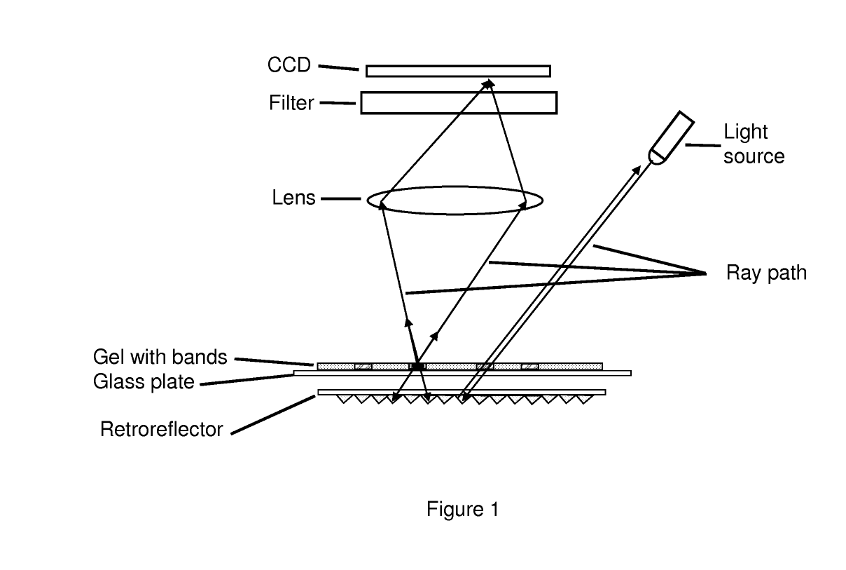

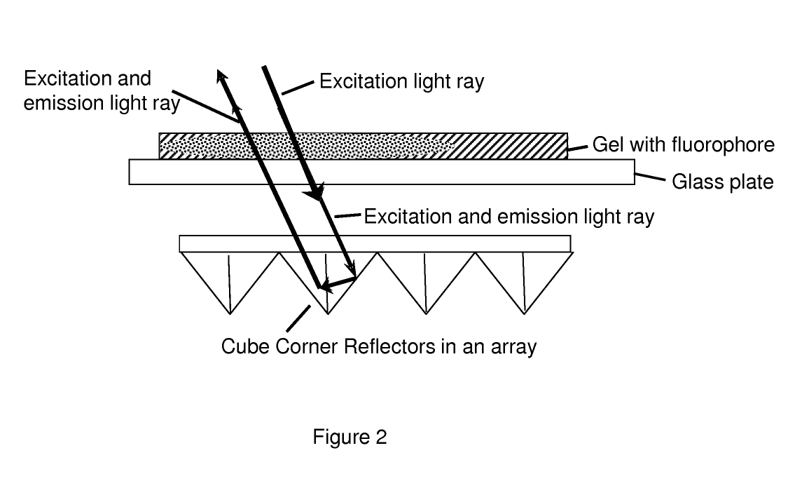

The principles and operation of the system and method according to the present invention may be better understood with reference to the drawings and accompanying descriptions. Referring now to the drawings, FIG. 1 illustrates a schematic ray path for fluorescent detection using the sample carrier according to an embodiment of the invention. FIG. 2 provides an enlarged view which illustrates the same principle. These figures show an example where the sample is non-autofluorescent. Should the sample be autofluorescent, the external light source is not needed.

Now referring to FIG. 1, the light source illuminates an exemplary analytical gel and its bands (For clarity, only one light source ray is shown in the figure). Note the gel is shown to be placed on a glass plate. Although there is a space shown between the glass plate and the retroreflector, it is not necessary. An excitation ray comes from a light source and goes through the gel and band. It travels through the sample carrier part (i.e., glass plate) to reach the light reflecting part (i.e., reretroreflector) and hits the retroreflector where it is reflected back in the opposite direction to the incoming excitation light ray. Thus the fluorescent molecules are excited with rays coming from above and below. The excitation light is hence utilized twice.

The fluorescent molecules in the gel band are excited and emit light isotropically in all directions. The arrows pointing upwards from the gel band represent rays from the emitting molecules and these are in the numerical aperture of the lens. They are collected and refracted in the lens and filtered in the emission filter and form an image of the band on a CCD. There are also rays emitted downwards from the sample gel band. These rays hit the retroreflector and are reflected back and go through the gel to the lens and are also refracted to form the image on the CCD. Thus the emitted light that goes downwards is also utilized to give a higher intensity at the image.

In one embodiment, the invention provides a sample carrier for increasing the sensitivity of luminescent light detection which comprises a sample carrying part and a light reflecting part. Preferably, the sample carrying part carries the sample on one side, and the light reflecting part is situated on the other side of the sample carrying part. Optionally, the light reflecting part is bonded on one side of the sample carrying part.

In one embodiment, the light reflecting part comprises a retroreflector. In a preferred embodiment, the light reflecting part comprises corner reflectors such as micro-corner reflectors. An example of such a micro-corner reflector is from Fresnel Optics GmbH (Germany).

In one embodiment, the sample carrying part is a microscopic slide.

In another embodiment, the sample carrier part is a glass plate.

According to another aspect of the present invention there is provided a method of increasing the sensitivity of an optical collection and detection system in detecting luminescent light emitted from a sample. The method comprises positioning the sample on a sample carrier described above, such that the optical collection and detection system collects both (1) luminescent light emitted from the sample positioned on the sample carrying part of the sample carrier in a direction of the optical collection and detection system, and (2) luminescent light emitted from the sample in a direction away from the optical collection and detection system, which is reflected in the direction of the optical collection and detection system via the light reflecting part.

In one embodiment, excitation light rays passing through the sample hit the light reflecting part of the sample carrier, and reflect back in the opposite direction thus the reflected excitation light also passes through the sample.

In one embodiment, the sample for the analysis is a biological sample. For example, the biological sample is selected from the group consisting of cells, phages, bacteria, nucleic acids, proteins, peptides and carbohydrates. As an example, the sample could be a protein or nucleic sample, marked with for example a Cy5 dye, separated on an electrophoretic analytical gel.

In another embodiment, the sample is a biological sample and sample carrying part is a chip to which the biological sample is bound. Preferably, the biological material is bound to the chip in an array format.

In another embodiment, the luminescent light emitted from the sample originates from autofluorescence of the sample. In another embodiment, the luminescent light emitted from the sample originates from a fluorescent probe interacting with the sample. In one example, the fluorescent probe includes a first member of a binding pair conjugated to a fluorescent tag. Optionally, the first member of the binding pair is selected from the group consisting of a nucleic acid, a ligand, a receptor, an antigen, an antibody, an enzyme, a substrate, a substrate analog and an inhibitor. Optionally, the fluorescent tag is selected from the group consisting of a fluorochrome, a quantum dot, a nanocrystal and a fluorescent protein.

Any optical collection and detection system can be used while implementing the present invention. This includes, but not limited to, a fluorescence scanner or microscope having an arc lamp such as a Xenon or Mercury lamp, a confocal microscope and an optical collection and detection system that includes a scanable light source, emitting, for example, coherent light, such as a laser light. Alternatively, the light source can be a light-emitting diode (LED) or an incandescent light source.

### EXAMPLES

The present examples are presented herein for illustrative purpose only, and should not be constructed to limit the invention as defined by the appended claims.

Reflector tests on the Ettan DIGE Imager (Unit 12)—051011

Three different Corner Cube Retro Reflectors from Frenel Optics GmbH have been tested in Ettan DIGE Scanner. The cube size for RF 090 was 0.152 mm per side, OT 853 0.864 mm, and OT 867 0.254 mm per side. The Retro Reflectors were placed at a distance of 1.5 mm from the gel containing a separate sample.

Scan settings: 100 μm, Cy5 channel, exp. Level: 0.02 s

TABLE 1
S/N ratios (calculated using Image Quant)

| | S/N ratios | | | | |
|---|---|---|---|---|---|
| | | | | | RF090_0_152_mm |
| dye (fmol) | ref | RF090_0_152_mm | OT853_0_864_mm | OT867_0_254_mm | 2^{nd} measurement |
| 1638.4 | 2747.224 | 3959.379 | 2574.740 | 3702.370 | 3965.812 |
| 819.2 | 1484.278 | 2332.037 | 1485.789 | 2298.607 | 2564.976 |
| 409.6 | 806.258 | 1341.970 | 916.073 | 1193.107 | 1165.597 |
| 102.4 | 230.607 | 374.954 | 253.053 | 355.995 | 434.586 |
| 12.8 | 45.094 | 78.137 | 44.906 | 69.127 | 77.311 |
| max intensity | 7273 | 13258 | 13433 | 13874 | 13036 |
| first band | | | | | |
| (1638 fmol) | | | | | |

S = background corrected signal
N = standard deviation of the background

TABLE 2
Ratio of S/N with Retro Reflector to S/N without Retro Reflector. (S/N from above)

| | | | | RF090_0_152_mm |
|---|---|---|---|---|
| dye (fmol) | RF090_0_152_mm | OT853_0_864_mm | OT867_0_254_mm | 2^{nd} measurement |
| 1638.4 | 1.44 | 0.94 | 1.35 | 1.44 |
| 819.2 | 1.57 | 1.00 | 1.55 | 1.73 |
| 409.6 | 1.66 | 1.14 | 1.48 | 1.45 |
| 102.4 | 1.63 | 1.10 | 1.54 | 1.88 |
| 12.8 | 1.73 | 1.00 | 1.53 | 1.71 |
| max intensity | 1.82 | 1.85 | 1.91 | 1.79 |
| first band | | | | |
| (1638 fmol) | | | | |

This test results show that there is an increase in signal/noise by a factor of up to 1.88 by using the Retro Reflectors. Cube corners shall be as small as possible. For the largest cube with side of 0.864 mm the image was distorted. Optimization of the distance of reflector to the sample containing gel could improve the signal.

All patents, patent publications, and other published references mentioned herein are hereby incorporated by reference in their entireties as if each had been individually and specifically incorporated by reference herein. While preferred illustrative embodiments of the present invention are described, one skilled in the art will appreciate that the present invention can be practiced by other than the described embodiments, which are presented for purposes of illustration only and not by way of limitation. The present invention is limited only by the claims that follow.

1. A sample carrier for increasing the sensitivity of luminescent light detection comprising:
a sample carrying part and a light reflecting part;
wherein said light reflecting part is positioned to allow an optical collection and detection system to collect not only luminescent light emitted from the sample positioned on said sample carrying part in a direction of said optical collection and detection system, but also luminescent light emitted from said sample in a direction away from said optical collection and detection system and reflected in the direction of said optical collection and detection system via said light reflecting part.

2. The sample carrier of claim 1, wherein said light reflecting part is also positioned to allow excitation light rays passing through the sample to hit said light reflecting part, and reflect back in the opposite direction thus the reflected excitation light also passes through said sample.

3. The sample carrier of claim 1, wherein said sample carrying part carries the sample on one side, and wherein said light reflecting part is on the other side of said sample carrying part.

4. The sample carrier of claim 1, wherein said light reflecting part is bonded on one side of said sample carrying part.

5. The sample carrier of claim 1, wherein said light reflecting part comprises a retroreflector.

6. The sample carrier of claim 1, wherein said light reflecting part comprises corner reflectors.

7. The sample carrier of claim 1, wherein said sample carrying part is a microscopic slide.

8. The sample carrier of claim 1, wherein said sample carrying part is a glass plate.

9. The sample carrier of claim 1, wherein said sample is a biological sample separated in an electrophoretic gel.

10. The sample carrier of claim 1, wherein said sample is a biological sample and said sample carrying part is a chip to which the biological sample is bound.

11. A method of increasing the sensitivity of an optical collection and detection system in detecting luminescent light emitted from a sample, the method comprising:
positioning the sample on a sample carrier comprising a sample carrying part and a light reflecting part,
wherein the optical collection and detection system collects both (1) luminescent light emitted from the sample positioned on said sample carrying part in a direction of said optical collection and detection system, and (2) luminescent light emitted from said sample in a direction away from said optical collection and detection system and reflected in the direction of said optical collection and detection system via said light reflecting part;
thereby increasing the sensitivity of luminescent light detection.

12. The method of claim 11, further wherein said light reflecting part is positioned such that excitation light rays passing through the sample hit said light reflecting part, and reflect back in the opposite direction thus the reflected excitation light also passes through said sample.

13. The method of claim 11, wherein said sample carrying part carries the sample on one side, and wherein said light reflecting part is on the other side of said sample carrying part.

14. The method of claim 11, wherein said light reflecting part is bonded on one side of said sample carrying part.

15. The method of claim 11, wherein said light reflecting part comprises a retroreflector.

16. The method of claim 11, wherein said light reflecting part comprises corner reflectors.

17. The method of claim 11, wherein said sample is a biological sample and said sample carrying part is a chip to which the biological sample is bound.

18. The method of claim 11, wherein said optical collection and detection system is a fluorescence scanner.

19. The method of claim 11, wherein said sample carrying part is a microscopic slide.

20. The method of claim 11, wherein said sample carrying part is a glass plate.

21. The method of claim 11, wherein said sample is a biological sample separated in an electrophoretic gel.

22. The method of claim 11, wherein said luminescent light emitted from the sample originates from autofluorescence of said sample.

23. The method of claim 11, wherein said luminescent light emitted from the sample originates from a fluorescent probe interacting with said sample.

24. The method of claim 23, wherein said fluorescent probe includes a first member of a binding pair conjugated to a fluorescent tag.

25. The method of claim 24, wherein said first member of said binding pair is selected from the group consisting of a nucleic acid, a ligand, a receptor, an antigen, an antibody, an enzyme, a substrate, a substrate analog and an inhibitor.

26. The method of claim 24, wherein said fluorescent tag is selected from the group consisting of a fluorochrome, a quantum dot, a nanocrystal and a fluorescent protein.

27. The method of claim 12, wherein said excitation light rays are from a scanable light source.

28. The method of claim 27, wherein said scanable light source emits coherent light.

29. The method of claim 12, wherein said excitation light rays are from an arc lamp, a light emitting diode or an incandescent light sources.
